(19) United States
(12) Patent Application Publication
(10) Pub. No.: US 2005/0099175 A1
(43) Pub. Date: May 12, 2005

(54) Rail activated position sensor

(76) Inventors: Susan M. Barnabo, Walpole, MA (US); Mark Freeman, Framingham, MA (US); Kayvan Hedayat, Weston, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/675,199

(22) Filed: Sep. 29, 2003

Related U.S. Application Data
(60) Provisional application No. 60/414,213, filed on Sep. 27, 2002.
(60) Provisional application No. 60/438,399, filed on Jan. 7, 2003.

(51) Int. Cl. G01B 7/14

(52) U.S. Cl. 324/207.2; 324/207.26; 324/207.13

(57) ABSTRACT

A position sensor including a sensor assembly adapted to mount to a first rail of an automotive seat rail assembly. The sensor assembly includes a Hall device and a magnet. The assembly is mountable to the first rail to cause a first output of the Hall device when the first rail is in a first position relative to a second rail of the automotive seat rail assembly, and to cause a second output of the Hall device when the first rail is in a second position relative to the second rail.

### CROSS-REFERENCE TO RELATED APPLICATIONS

This application claims the benefit of U.S. provisional application Ser. No. 60/414,213, filed Sep. 27, 2002, the entire disclosure of which is incorporated herein by reference.

### FIELD OF THE INVENTION

The present invention relates in general to position sensors, and, more particularly, to a non-contact position sensor for sensing the position of a movable item such as an automobile seat.

### BACKGROUND OF THE INVENTION

In a wide variety of applications it is advantageous or necessary to sense the position of a linearly or rotationally movable element. For example, in automobile seat applications the seat may be linearly movable, either manually or automatically via electro-mechanical means, on an associated track assembly. A sensor may provide a signal representative of the linear position of the seat on the track for a variety of purposes, e.g. to control deployment of an air bag, to control the electro-mechanical actuator that causes translation of the seat in connection with a seat position memory feature, etc.

For a seat position application, it is increasingly desirable for a sensor to provide multiple position outputs for purposes of ascertaining occupant position. For example, in applications where seat position is used to control air bag deployment early configurations involved only single stage air bag systems. A single stage air bag deploys with a known deployment force that may not be varied. In this application, seat position information was used only to determine when the airbag should be deployed. However, the advent of dual stage air bags, i.e. air bags that may be deployed with two distinct deployment forces, required increased resolution in position sensing. Also, the industry is now moving to variable stage airbags where the deployment force may be varied depending upon occupant position and classification. Variable stage airbag configurations will require a sensor that can detect multiple seat positions for use in determining the appropriate deployment force.

Another desirable feature of a position sensor, especially in the context of an automobile seat application, is that it be non-contact. A non-contact sensor has a sensing element that does not physically contact the sensed object. It is also advantageous that the sensor be mechanically decoupled from the seat track in an automobile seat application. These features allow quiet operation of the sensor and minimize wear, which could cause deterioration of performance.

Another difficulty associated with seat position sensors is that the seat track environment is very crowed. Also the space available for the sensor may vary from among vehicle types. The size and packaging of the sensor should, therefore, be flexible to allow use in a variety of vehicle types. In addition, it would be advantageous to have a menu of sensor configurations to allow selective use of an appropriate configuration depending on the track environment.

One known variety of seat position sensors includes a U-shape sensor having a Hall effect sensor in a first leg of the U-shape sensor and a magnet in the opposed leg of the sensor. A shunt is mounted on one of the seat rails in a moving relationship to the U-shape sensor. In one position sensed by the sensor the shunt is disposed between the magnet and the Hall effect sensor, thereby blocking the magnetic field from the magnet to the Hall effect sensor. One drawback of this sensor configuration is the need to attach a shunt to the crowded environment of the seat track.

Accordingly, there is a need for a non-contact position sensor that provides accurate and reliable position sensing that may be cost-effectively produced and installed.

### SUMMARY OF THE INVENTION

According to one aspect of the invention, a non-contact position sensor consistent with the present invention includes a sensor assembly including at least one magnet disposed adjacent a magnetic field sensor, and an activating member. The magnetic field sensor provides a first output when the activating member is in a first position relative to the sensor assembly and a second output when the activating member is in a second position relative to the sensor assembly. The activating member does not extend between the magnet and the magnetic field sensor in either of the first and the second positions.

According to another aspect of the invention, a seat position sensor system consistent with the present invention includes a seat rail system including a movable rail and a stationary rail, and a sensor assembly including at least one magnet and a Hall device. The sensor assembly is mounted to a first of the movable rail and the stationary rail. The Hall device provides a first out put when the movable rail is in a first position relative to the stationary rail a second output when the movable rail is in a second position relative to the stationary rail. The second one of the movable rail and the stationary rail does not extend between the at least one magnet and the Hall device in either of the first position and second position.

According to yet another aspect of the invention, a method of sensing vehicle seat position consistent with the present invention includes providing a sensor assembly comprising at least one magnet and a Hall device and mounting the sensor assembly to a first seat rail. The Hall device provides a first output when the sensor assembly is in a first position relative to a second seat rail and a second output when the sensor assembly is in a second position relative to the second seat rail. The second seat rail does not extend between the at least one magnet and the Hall device in either of the first and second positions. The position of the seat is determined in response to the output of the Hall device.

According to still another aspect, a sensor consistent with the present invention includes at least one magnet, and a magnetic field sensor disposed adjacent the at least one magnet. The magnetic field sensor provides a first output when an activating member is in a first position relative to the at least one magnet and the magnetic field sensor and a second output when the activating member is in a second position relative to the at least one magnet and the magnetic field sensor. The activating member does not extend between the at least one magnet and the magnetic field sensor in either of the first and second positions.

### BRIEF DESCRIPTION OF THE DRAWING

For a better understanding of the present invention, together with other objects, features and advantages, reference should be made to the following detailed description which should be read in conjunction with the following figures wherein like numerals represent like parts:

FIGS. 1a and 1b are perspective view of an exemplary sensor system consistent with the present invention respectively showing orientation of the sensor in a first position relative to the stationary rail where the sensor provides a first output, and a second position relative to the stationary rail where the sensor provides a second output;

FIG. 2 is a front cross-sectional view of an exemplary sensor assembly consistent with the present invention mounted to an automobile seat rail system;

FIG. 3 is a front view of an exemplary sensor assembly consistent with the present invention mounted to an automobile seat rail system and showing the magnetic circuit formed by the sensor and rail system when the sensor is in the first position shown in FIG. 1a;

FIG. 4 is a front view of the exemplary sensor assembly shown in FIG. 3 mounted to the automobile seat rail system an showing the magnetic circuit when the sensor is in the second position shown in FIG. 1b;

FIGS. 5 through 13 are front views of varying exemplary sensor systems consistent with the present invention mounted to the movable rail of an automobile seat rail system, wherein the top drawing depicts the sensor assembly and movable rail alone, and the bottom drawing shows the sensor assembly mounted to the movable rail with the stationary rail positioned proximate the sensor assembly;

FIGS. 14 through 21 show various exemplary sensor systems consistent with the present invention mounted to the stationary rail of an automobile sear rail system in front view, wherein the top drawing of each figure shows the sensor assembly mounted to the stationary rail alone and the bottom drawing depicts the sensor assembly mounted to the stationary rail with the movable rail proximate the sensor assembly;

FIG. 22 is a schematic view showing the magnetic field lines associated with a magnet having a C-shaped cross-section when the sensor is proximate the rail;

FIG. 23 is a plot of the magnetic field along the magnet height for a magnet having a C-shaped cross-section;

FIG. 24 is a schematic view showing the magnetic field lines associated with a magnet system including two magnets when the sensor is proximate the rail; and

FIG. 25 is a plot of the magnetic field along the magnet height for the two magnet system of FIG. 24.

### DETAILED DESCRIPTION

A non-contact sensor system consistent with the present invention may a sensor assembly including at least one magnet and a magnetic field sensor. The magnetic field sensor provides a first output when an activating member is disposed in a first position relative to the sensor assembly and the magnetic field sensor provides a second output when the activating member is in a second position relative to the sensor assembly. According to a particular example, the activating member redirects and/or influences the path of the magnetic field of the sensor assembly magnet. The magnetic circuit of the sensor is designed to cause a Hall sensor to change state by the presence or absence of an activating member in the magnetic circuit of the sensor. Because the sensor consistent with the present invention operates based on the activating member influencing and/or redirecting the magnetic field of the sensor magnet, the activating member need not be disposed between the at least one magnet and the magnetic field sensor in either of the first or second positions.

For ease of explanation, sensor systems consistent with the invention will be described herein in connection with an automobile seat position sensing application. It will be recognized, however, that sensor systems consistent with the invention will be useful in other applications. In addition, the exemplary embodiments described herein include the use of Hall Effect sensors and a magnet. Those skilled in the art will recognize, however, that a variety of sensing means may be used. For example, optical, magneto-resistive, fluxgate sensors, etc. may be useful in connection with a sensor system consistent with the invention. In alternative embodiments sensor control elements other than magnets or activating members, e.g. an optical source, may be used. It is to be understood, therefore, that illustrated exemplary embodiments described herein are provided only by way of illustration, and are not intended to be limiting.

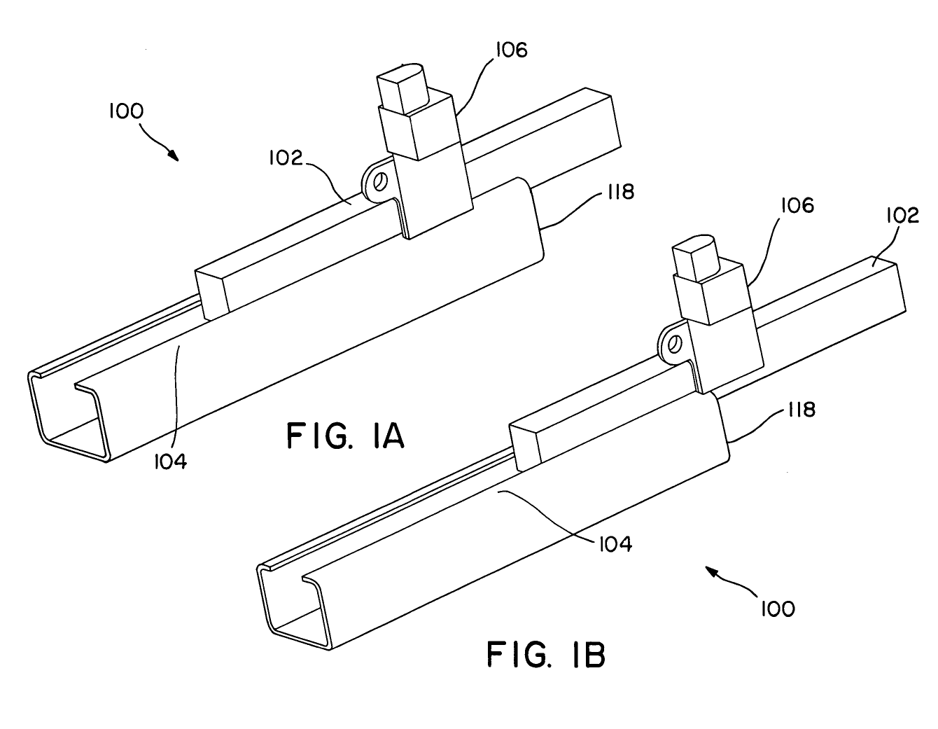

Turning to FIGS. 1a and 1b, there is illustrated a perspective view of one exemplary embodiment of a sensor system 100 consistent with the invention. The illustrated system generally includes an automotive seat rail system including a movable upper seat rail 102 and a stationary lower seat rail 104. A non-contact sensor assembly 106 may be mounted to, and travel with, the upper rail 102. The sensor assembly 106 is configured to provide a first output when the rails 102 and 104 are positioned relative to one another such that sensor assembly 106 is proximate the lower rail 104, as shown in FIG. 1a, and a second output when the rails 102, 104 are positioned to place the sensor assembly 106 at least partially beyond the lower rail 104, as shown in FIG. 1b.

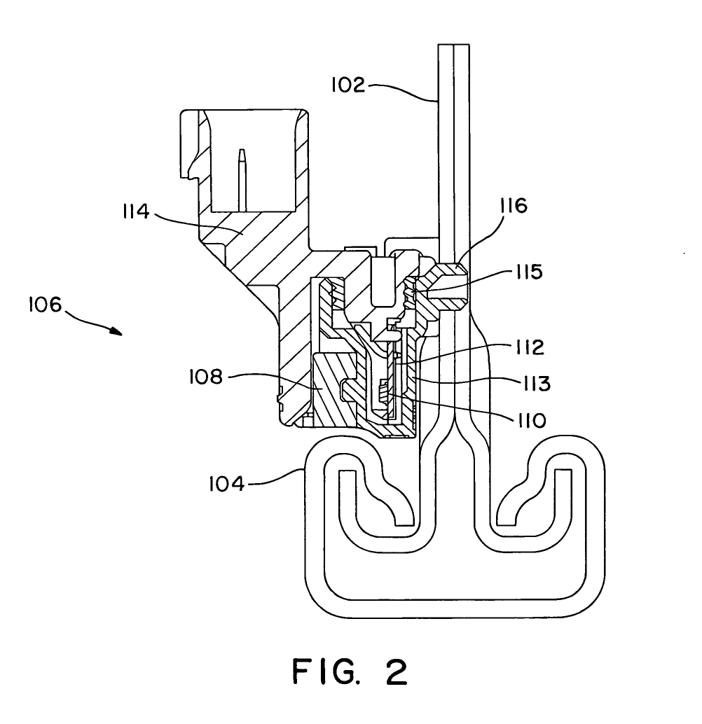

The exemplary sensor assembly 106 is shown in cross-sectional view in FIG. 2. As in FIG. 1, the sensor assembly 106 is mounted to a movable rail 102 that moves relative to a lower stationary rail 104. The sensor assembly 106 includes a Hall Effect IC (Hall Device) 110 positioned on a PCB 112 and a magnet 108 disposed adjacent the Hall Effect IC 110. The sensor assembly 106 also generally includes a mating connector 114 for coupling the sensor output to other systems. The mating connector 114 may be configured according to any of various standard connector designs commonly utilized, and may be integrally formed with the injection molded housing. The sensor assembly 106 may be mounted by a variety of means, e.g. by fasteners 116 positioned to engage dedicated mounting holes in the movable upper rail 102. It is to be understood that, although the sensor in the illustrated embodiment is shown as being mounted to the movable upper rail 102, it could alternatively be mounted to the stationary lower rail 104.

In one exemplary embodiment, the magnet may have a height of about 9 mm. The Hall device may be positioned 2.78 to 3.15 mm from the front face of the magnet 108, and about 0.61 mm down from the magnet centerline. A gap of about 5 mm may be provided between the magnet face and the “J” portion of the movable rail, and an air gap of 0.5 to 2.75 mm may be provided between the magnet face and the actuating or target rail. Of course, these dimensions may vary depending on the particular application.

As shown in FIG. 2, the Hall device may be enclosed in the sensor housing 113. The PCB 112 may be sealed in the housing 113, for example, using a perimeter seal, grommet, O-ring 115. The PCB may also be sealed in the housing by welding, e.g., ultrasonic or thermal welding, bonding using an adhesive such as epoxy, or otherwise sealing the housing. Alternatively, the PCB may be enclosed, for example, by over-molding the PCB.

Advantageously, the Hall device may be a programmable two-wire Hall device, thereby providing low current device with diagnostic capabilities. Such a device may be useful over a wide voltage and temperature range, while providing nominal current outputs of, for example, 5.5 ma and 15 mA. The device may be programmed in a variety of ways to eliminate component variation. For example, the Hall device may be programmed with the sensor mounted to a mock track at worst case track and mounting hole tolerance conditions. Alternatively, the sensor may be programmed by locating the sensor to an air gap dimension. The sensor can then be mounted at the programmed air gap dimension, e.g. via a shim. Of course, the sensor could also be programmed after it is mounted to its associated track.

In the embodiment illustrated in FIG. 2, the magnet 108 has a face directly opposed to the stationary rail and is not sealed or enclosed within the housing. The magnet 108 may be heat staked to the housing or secured to the housing by some other means, e.g. interference fit, adhesive etc. This configuration may be employed to reduce the distance between the magnet and actuation rail when the rail is proximate the sensor. However, in alternative embodiments it may be desirable to provide the magnet in a sealed housing, especially if the sensor is to be used in particularly harsh environments.

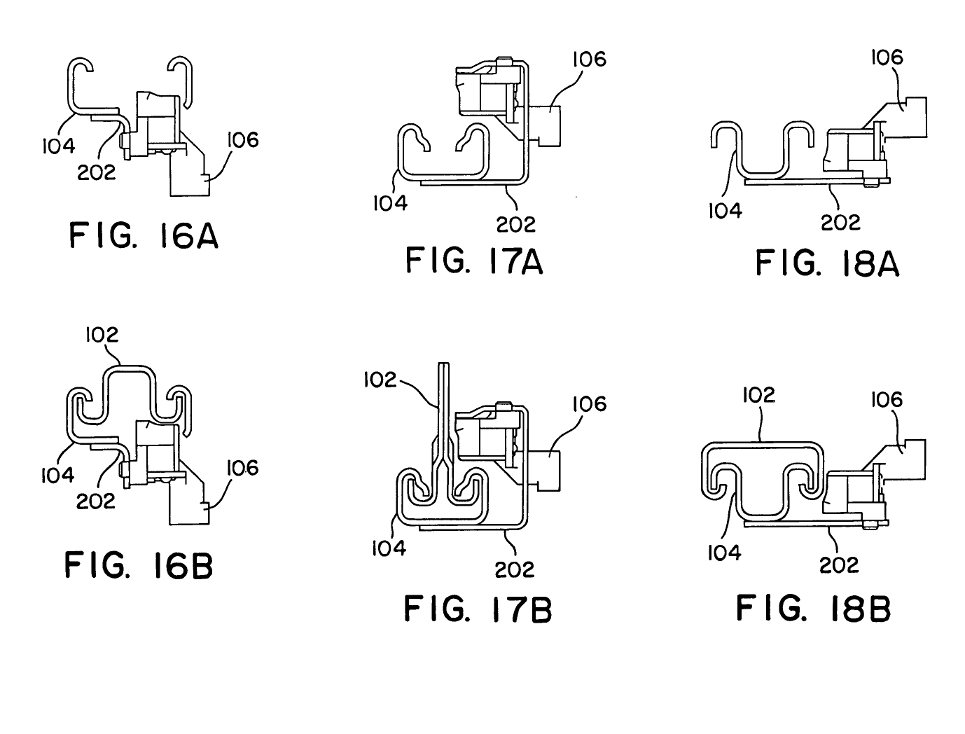

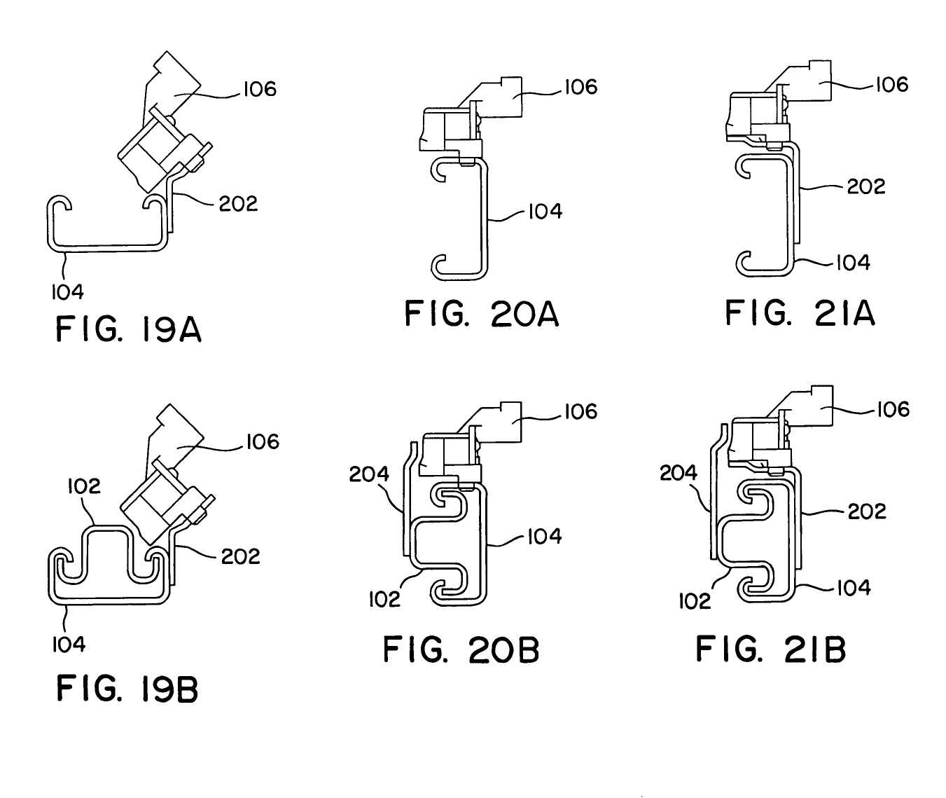

Also as shown in the exemplary embodiment, the magnet 108 may have a generally C-shaped cross-section. Referring to FIG. 22, a schematic view of the magnetic field lines associated with a magnet 302 having a C-shape cross-section when an activating rail 303 is proximate the sensor. FIG. 23 is a plot of the magnetic field along the magnet height for the magnet configuration shown in FIG. 22 where the field is measured along a line L corresponding to the location of the hall sensor 110. It can be seen from the plot that the difference in the magnetic field when an activating rail 303 is proximate the magnet 302 and when no rail is proximate the magnet is especially pronounced between a height of about 3 to 5 mm above the bottom of the magnet. The region of the most pronounced difference in the strength of the magnetic field may be an especially advantageous region for placing the Hall device. However, as indicated by the plot, depending upon the sensitivity of the Hall device, the Hall device may suitably placed at other heights from the bottom of the magnet as well.

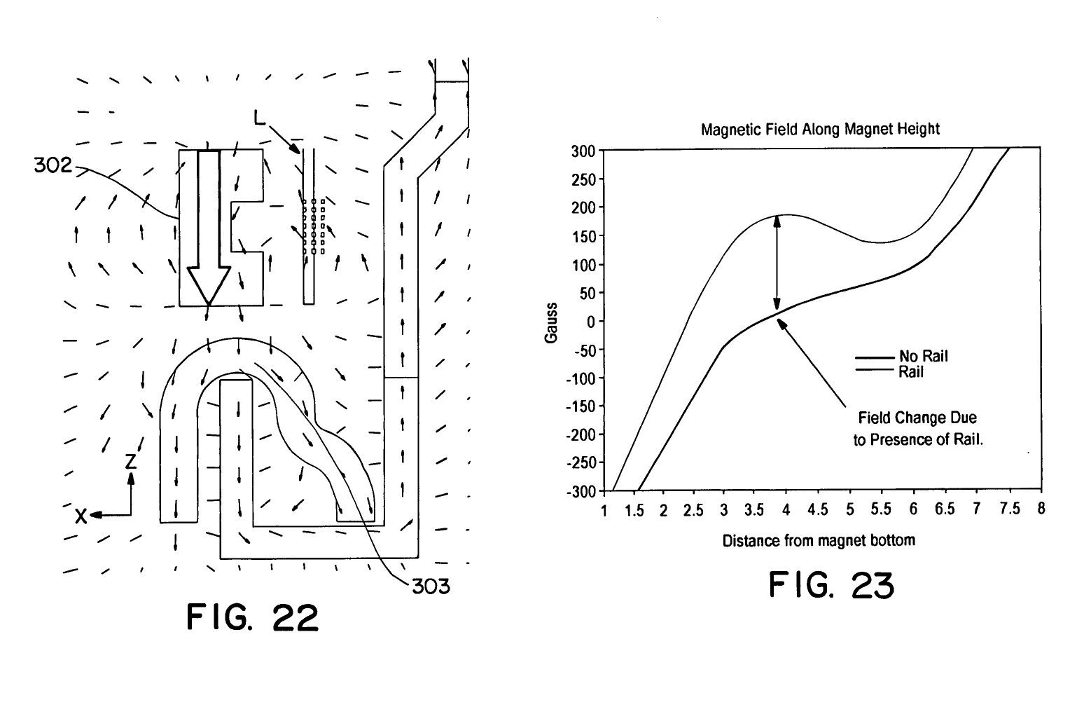

FIG. 24 illustrates another exemplary magnet configuration including two generally rectangular cross-section magnets 304, 306. Magnetic field lines associated with the two magnets 304, 306 are shown with the presence of an activating rail 303 proximate the sensor. The magnetic field associated with the pair of magnets 304, 306 is generally comparable to the magnetic field produced by a magnet having a C-shape cross-section.

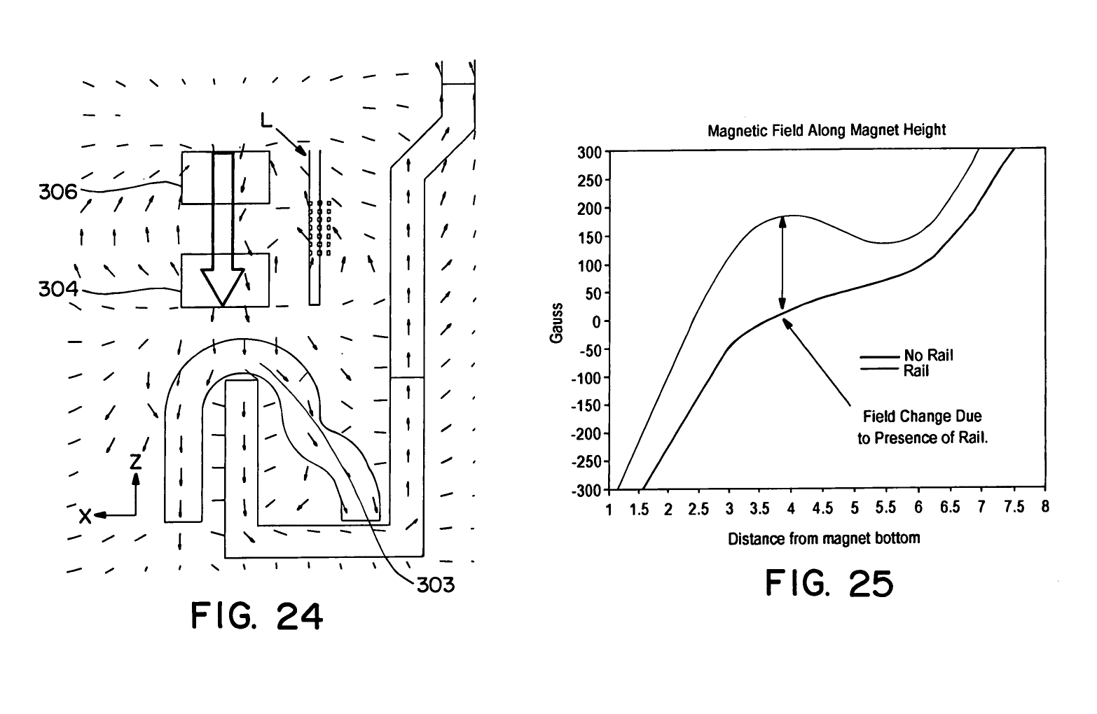

Turning to FIG. 25, the plot of magnetic field along magnet height for the two magnet configuration shown in FIG. 24 further indicates that the performance of a two magnet configuration is similar to the performance of a C-shape cross-section magnet. Specifically, there is an increase or exaggeration in the difference between the magnetic field in the presence of a proximate activating rail and in the absence of a proximate activating rail from about 3 to 5 mm above the bottom of the magnet. As with the exemplary embodiment depicted in FIGS. 22 and 23, when the two magnet configuration, as illustrated, is employed the Hall device may be especially advantageously positioned in the range of between about 3 to 5 mm from the bottom of the magnet. While a Hall sensor in other positions will discern a difference in the magnetic field when an activating rail is proximate the sensor or not, the 3 to 5 mm height range requires the least sensitive Hall device.

Those having skill in the art will recognize that numerous other magnet configurations may be used consistent with the invention herein. Additional magnet configurations may include single or multiple magnets configured in generally rectangular cross-section, as well as I-shape cross-section, H-shape cross-section, T-shape cross-section, etc.

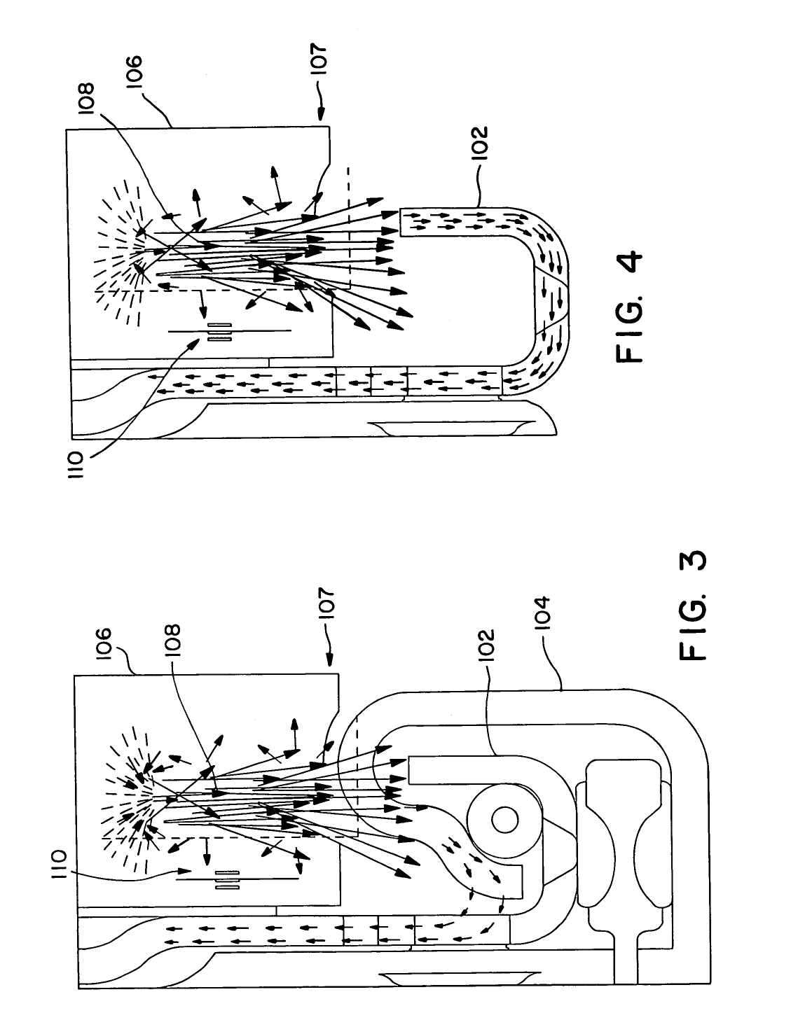

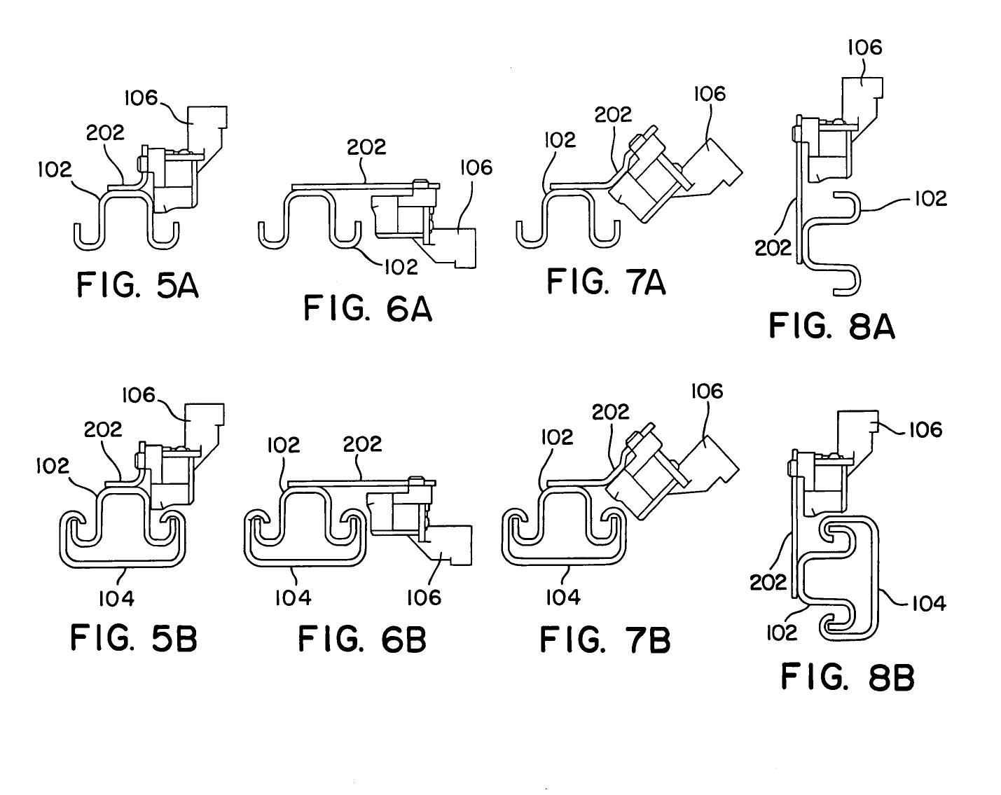

Turning next to FIGS. 3 and 4, as discussed with reference to FIGS. 1a and 1b, a sensor assembly 106 consistent with the present invention is configured to provide a first output when the when the movable rail 102 and stationary rail 104 are positioned to place the sensor portion 107 of the sensor assembly 106 proximate the stationary rail 104, and to provide a second output when the movable rail 102 and stationary rail 104 are positioned to place the sensor portion 107 at least partially beyond the end 118 of the stationary rail 104. With reference to FIG. 3, for example, the movable rail 102 is positioned relative to the stationary rail 104 so that the sensor 107 is positioned proximate the stationary rail 104. As shown, in this position, the magnetic circuit for the flux associated with the sensor magnet 108 includes both the movable rail 102 and the stationary rail 104. It is noted that in the illustrated embodiment, the Hall device 110 is positioned relative to the North/South poles of the magnet so that the magnetic flux passes through the rails 102, 104 and the Hall device 110, as shown in FIG. 3. The flux imparted to the Hall device 110 thus has a first level causing a first output of the Hall device 110.

However, as shown in FIG. 4, when the movable rail 102 is positioned relative to the stationary rail 104 so that the sensor 107 is disposed at least partially beyond the end 118 of the stationary rail 104, the effect of the stationary rail 104 on the magnetic flux imparted to the Hall device 110 is significantly changed. In this position, the flux imparted to the Hall device 110 has a second level causing a second output of the Hall device 110 that is distinct form the first output. Thus, the position of the movable rail 102 relative to the stationary rail 104 can be determined from the output of the Hall device 110. This output may be used to control or signal other vehicle systems, such as air bag deployment systems.

In addition to the first and second outputs indicative of whether the sensor 107 is positioned proximate the stationary rail, a sensor system consistent with the present invention may be configured to provide additional outputs corresponding to various intermediate positions. For example, the stationary rail may have a stepped configuration, whereby the air gap between the sensor 107 and the stationary rail 104 varies about the range of motion of the movable rail 102. The changes in the air gap between the sensor 107 and the stationary rail may produce corresponding changes in the neutral axis of the magnetic field. The shift in the neutral axis of the magnetic field associated with the sensor magnet 108 will produce corresponding changes to the flux imparted to the Hall device 110.

The exemplary embodiments illustrated in FIGS. 1 though 4 each utilize one of the seat rails as an activating member, wherein the presence of the activating rail proximate the sensor produces a first output of the sensor and the absence of the activating rail proximate the sensor produces a second output of the sensor. It should be understood, however, that the activating member may include, for example, an activating plate, etc., wherein the sensor produces a first output when the activating plate is proximate the sensor and the sensor produces a second output when the activating plate is not proximate the sensor.

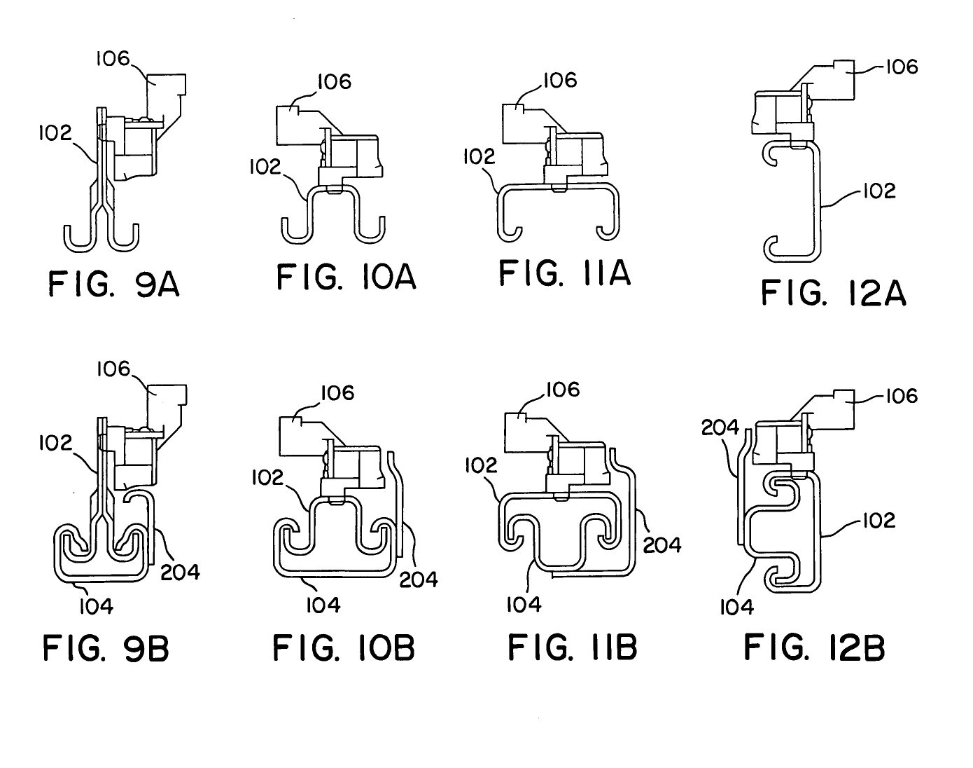

A sensor consistent with the present invention can be incorporated into a wide variety of vehicle rail configurations. FIGS. 5 through 13 depict several different sensor mounting configurations in which the sensor assembly 106 is mounted on the movable rail 102. In each of the figures, the top drawing illustrates the sensor assembly 106 and the movable rail 102, i.e., the configuration associated with the second output, as previously described. The bottom drawing of each figure illustrates the sensor assembly 106 mounted to the movable rail 102 with the stationary rail 104 positioned proximate the sensor assembly 106, i.e., the configuration associated with the previously described first output.

FIGS. 5 through 8 illustrate various different exemplary embodiments in which the sensor assembly 106 is mounted to the movable rail 102 via a mounting bracket 202. As shown, the mounting bracket 202 may be provided having numerous shapes and configurations to accommodate different rail configurations and desired sensor positions.

Turning next to FIGS. 9 through 12, various different exemplary embodiments of illustrated in which the sensor assembly 106 is mounted directly to the movable rail 102. In each of the exemplary embodiments shown in this series of figures, an activating member 204 is mounted to the stationary rail 104. Consistent with the present invention the activating member 204 may be a rail, plate, etc. mounted on to the stationary rail, or other adjacent structure, e.g., floor, frame member etc. When the activating member 204 is positioned proximate the sensor portion 107 of the sensor assembly 106, the activating member effects the magnetic flux imparted to the Hall device. In operation, positioning of the activating member 204 proximate to the sensor 107 has the same effect as positioning the stationary rail proximate to the sensor 107.

FIGS. 5 through 10 all depict the movable rail 102 configured to be the inner rail of the automotive seat rail system. That is, the movable rail 102 is disposed within a channel formed by the stationary rail 104. As shown in FIGS. 11 and 12, the movable rail 102 may also be configured as the outer rail of the automotive seat rail system, wherein stationary rail 104 is disposed in a channel formed by the movable rail 102. Of course, various additional and alternative configurations may be suitable employed.

FIG. 13 illustrates an exemplary sensor system that is a further combination of the previously discussed elements. The sensor system includes a sensor assembly 106 mount to the movable rail 102 via a mounting bracket 202. The stationary rail 104 includes an activating member 204 that is mounted on the stationary rail. As in the embodiments illustrated in FIGS. 9 through 12, the output of the Hall device depends on the relative positioning between the sensor and the activating member 204. When the activating member 204 is proximate the sensor the magnetic flux imparted to the Hall device is at a first state producing the first output, and when the activating member 204 is not proximate the sensor, the magnetic flux imparted to the Hall Device is at a second state producing the second output.

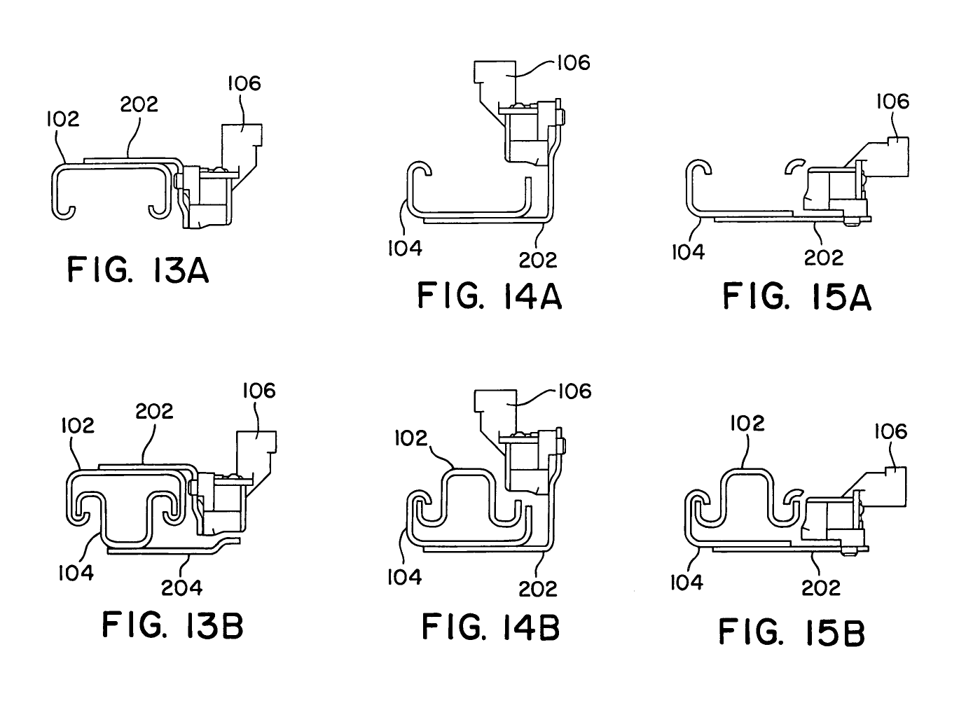

Turning next to FIGS. 14 through 21, several further exemplary sensor systems consistent with the present invention are illustrated. In each of this group of exemplary sensor systems, the sensor assembly is mounted to the stationary rail 104. In a similar manner to the preceding embodiments, the output of the Hall device corresponds to the relative position of the movable rail 102 to the stationary rail 104, and there the sensor assembly 106. In a similar manner to FIGS. 5 through 13, in each of FIGS. 14 through 21 the top illustration depicts the stationary rail 104 alone with the sensor assembly 106. The bottom illustration of each figure shows the senor assembly proximate to the movable rail 102.

FIGS. 14 through 19 each depict an embodiment of a sensor assembly consistent with the present invention in which the sensor assembly 106 is mounted to the stationary rail 104 via a sensor assembly mounting bracket 202. As shown in the drawings, the bracket 202 may have numerous configurations, and the bracket 202 may be mounted to any number of locations on the stationary rail 104. In each of these embodiments, the magnetic flux imparted to the Hall device is changed by the proximity of the movable rail 102. That is, when the movable rail 102 is proximate the sensor the magnetic flux imparted to the Hall device is in a first state producing a first output of the Hall device, and when the movable rail 102 is not proximate the sensor the magnetic flux imparted to the Hall device is in a second state producing a second output of the Hall device.

FIG. 20 similarly depicts an exemplary sensor system consistent with the present invention, wherein the sensor assembly 106 is mounted to the stationary rail 104, although without the use of a bracket. Differing from the preceding embodiments, however, the output of the Hall device is changed by proximity to an activating member 204 mounted to the movable rail 102.

The final illustrated embodiment in which the senor assembly 106 is mounted to the stationary rail 104 combines some of the aspects of FIGS. 14 though 19 and FIG. 20. In the embodiment of FIG. 21 the sensor assembly 106 is mounted to the stationary rail 104 via a bracket 202. The output of the Hall device is changed by proximity of an activating member 204 mounted to the movable rail 102.

Those having skill in the art will appreciate that the above exemplary embodiments are susceptible to further combination and variation. Consistent with the present invention, the sensor assembly 106 may be mounted to either to movable rail 102 or the stationary rail, as well as any structure adjacent to the rails. Furthermore, the sensor assembly 106 may either be mounted directly to one of the rails 102, 104 or mounted indirectly via a bracket 202 or similar interposed structure. Finally, it should be understood that, consistent with the present invention, the magnetic flux imparted to the Hall device may be changed either by the proximity of one of the rails 102, 104 to the sensor or by proximity of a secondary structure, e.g., an activating member 204, that is movable relative to the sensor.

The embodiments that have been described herein, however, are but some of the several which utilize this invention and are set forth here by way of illustration but not of limitation. Additionally, it will be appreciated that aspects of the various embodiments may be combined in other embodiments. It is obvious that many other embodiments, which will be readily apparent to those skilled in the art, may be made without departing materially from the spirit and scope of the invention as defined in the appended claims.

1. A non-contact position sensor comprising:
a sensor assembly comprising at least one magnet disposed adjacent a magnetic field sensor; and
an activating member;
said magnetic field sensor providing a first output when said activating member is in a first position relative to said sensor assembly and a second output when said activating member is in a second position relative to said sensor assembly, said activating member not extending between said magnet and said magnetic field sensor in either of said first and said second position.

2. The position sensor of claim 1 wherein said magnetic field sensor comprises a Hall sensor.

3. The position sensor of claim 1 wherein said sensor assembly is mounted to a rail of an automobile seat rail system.

4. The position sensor of claim 3 wherein said sensor assembly is mounted directly to said rail.

5. The position sensor of claim 3 wherein said sensor assembly is mounted to said rail via a bracket.

6. The position sensor of claim 1 wherein said activating member is a rail of an automobile seat rail system.

7. The position sensor of claim 1 wherein said activating member is attached to a rail of an automobile seat rail system.

8. The position sensor of claim 1 wherein said sensor assembly is mounted on a first rail of an automobile seat rail system and the activating member is a second rail of said automobile seat rail system.

9. The position sensor of claim 1 wherein said at least one magnet has a C-shape cross section.

10. The position sensor of claim 1 wherein said at least one magnet comprises a first and second magnets.

11. A seat position sensor system comprising:
a seat rail system comprising a movable rail and a stationary rail;
a sensor assembly comprising at least one magnet and a Hall device, said sensor assembly being mounted to a first of said movable rail and said stationary rail; and
said Hall device providing a first out put when said movable rail is in a first position relative to said stationary rail a second output when said movable rail is in a second position relative to said stationary rail, said second of said movable rail and said stationary rail not extending between said at least one magnet and said Hall device in either of said first position and second position.

12. The system of claim 11 wherein said sensor assembly is mounted to said movable rail.

13. The seat position sensor of claim 11 wherein said sensor assembly is mounted to said stationary rail.

14. The system of claim 11 wherein said sensor assembly is mounted to one of said movable rail and said stationary rail via a mounting bracket.

15. The system of claim 11 wherein said at least one magnet comprises a C-shape magnet.

16. The system of claim 11 wherein said at least one magnet comprises a first and second magnet.

17. The system of claim 11 wherein one of said movable rail and stationary rail comprises an activating member, said activating member being in a first activating position relative to said sensor assembly when said movable rail is in said first position relative to said stationary rail, and said activating member being in a second activating position relative to said sensor assembly when said movable rail is in said second position relative to said stationary rail, said activating member not extending between said at least one magnet and said Hall device in either of said first and second activating positions.

18. A method of sensing vehicle seat position comprising:
providing a sensor assembly comprising at least one magnet and a Hall device;
mounting said sensor assembly to a first seat rail, said Hall device providing a first output when said sensor assembly is in a first position relative to a second seat rail and a second output when said sensor assembly is in a second position relative to said second seat rail, said second seat rail not extending between said at least one magnet and said Hall device in either of said first and second positions; and
determining a position of said seat in response to said output.

19. The method of claim 18 further comprising mounting an activating member to said second seat rail, said Hall device providing a first output when said activating member is in a first position relative to said sensor assembly and a second output when said activating member is in a second position relative to said sensor assembly, said activating member not extending between said at least one magnet and said Hall device in either of said first and second position of said activating member.

20. A sensor comprising:
at least one magnet;
a magnetic field sensor disposed adjacent said at least one magnet;
said magnetic field sensor providing a first output when an activating member is in a first position relative to said at least one magnet and said magnetic field sensor and a second output when the activating member is in a second position relative to said at least one magnet and said magnetic field sensor, the activating member not extending between said at least one magnet and said magnetic field sensor in either of said first and second positions.
